(19) United States
(12) Patent Application Publication
(10) Pub. No.: US 2005/0197889 A1
(43) Pub. Date: Sep. 8, 2005

(54) Method and apparatus for comparison over time of prediction model characteristics

(75) Inventors: Sergey A. Prigogin, Foster City, CA (US); Michel Adar, Palo Alto, CA (US); Nicolas M. Bonnet, Palo Alto, CA (US)

Correspondence Address: BEYER WEAVER & THOMAS LLP, P.O. BOX 70250, OAKLAND, CA, 94612-0250, US

(73) Assignee: Sigma Dynamics, Inc.

(21) Appl. No.: 11/045,665

(22) Filed: Jan. 28, 2005

Related U.S. Application Data
(60) Provisional application No. 60/544,291, filed on Feb. 11, 2004.

(51) Int. Cl. G06F 17/60

(52) U.S. Cl. 705/10

(57) ABSTRACT

Disclosed are methods and apparatus for reporting significant data mining changes. In general, embodiments of the present invention address the shortcomings of the prior art through comparison over time of prediction model characteristics, such as inferences. Embodiments of the present invention detect trends in the model itself by detecting changes in levels of correlation (or any other model aspect) between individual elements of input data and targets of predictions. In this specific embodiment, users of the model are preferably alerted when an input characteristic or other model aspect, which was not important before, becomes important and when an input characteristic, which was important, loses its importance.

### CROSS REFERENCE TO RELATED PATENT APPLICATION

This application claims priority of U.S. Provisional Patent Application No. 60/544,291 (Attorney Docket No. SIGMP005P), entitled “COMPARISON OVER TIME OF ANALYTICAL MODEL INFERENCE”, filed 11 Feb. 2004 by Sergey A. Prigogin et al., which application is incorporated herein by reference in its entirety for all purposes.

### BACKGROUND OF THE INVENTION

The present invention relates to the general technical area of modeling interactions between various entities, such as a customer and a telephone call center. More specifically, it relates to utilizing self-learning predictive models and monitoring aspects of such models.

Consumers of products and services are increasingly using automated interaction channels such as Internet web sites and telephone call centers. Such automated sales channels typically provide an automated process which attempts to match potential customers with desirable products and/or services. In the case of web sites, the interaction channel may be fully automated. In the case of call centers, human customer-service agents are often used. One goal of the companies selling the products and services is to maximize total enterprise profitability and, therefore, companies will often invest heavily in creating computerized models in an attempt to maximize their revenue and minimize their expenses for both of these types of sales channels.

Prediction modeling is generally used to predict the outcome of numerous decisions which could be implemented. In a most simplistic example, a prediction model may predict the likelihood (or probability) of a particular result or outcome occurring if a particular action was performed (e.g., a particular decision is carried out) under one or more specific conditions. In a more complex scenario, a prediction model may predict the probabilities of a plurality of outcomes for a plurality of actions being performed under various conditions.

In a specific application, prediction modeling may be used to decide which specific interactions are to be taken by a company's service or product sales center (e.g., website or telephone call center) when a customer is interacting with such center. The prediction modeling helps the company select an interaction that is likely to result in a desirable goal being met. Automated sales centers, for example, typically provide an automated process which attempts to match potential or current customers with desirable products and/or services. In the case of websites, the sales center may be fully automated. In the case of call centers, human customer-service agents in conjunction with automated interactive voice recognition (IVR) processes or agents are often used.

For example, a customer may go to a particular website or call center of a company which specializes in selling automobiles. From the company's perspective, the company may have a goal of maximizing automobile revenue to each customer who interacts with its website or telephone call center. When a customer initially accesses the website or call center, it may be possible to select any number of sales promotions to present to the customer (e.g., via a web page or communicated by a human sales agent). Prediction models may be used to determine which sale promotion to present to a given customer to more likely achieve the goal of maximizing sales revenue. For instance, it may be determined that a particular type of customer is highly likely to buy a particular type of automobile if presented with a sales presentation for such item.

There has been a recent trend towards the creation of self-learning predictive models. That is, there are no preset rules or biases as with business rule modeling. Self-learning models observe the interactions of customers with the system and adjusts itself accordingly. Since the self-learning models adjusts themselves based on the data they collect, automatic data mining routines are typically employed to alert when various parameters change. For instance, the sell rate of a product may decline or increase.

However, it is often meaningless to merely send alerts when a parameter changes as there is natural variation in any dataset. One prior art method to address this shortcoming is to set an alert level. For example, when a parameter change is greater than the alert level, the appropriate indication flags are set. While an improvement over flagging every change, alert levels are typically fixed and do not necessarily account for all changes in a dataset. For example, an incoming data stream may become less variable over time and a significant change may occur that is not picked up by an alert level. Conversely, an incoming data stream may become more naturally variable and the alert level is being flagged when the changes are not significant.

Additionally, the selection of which parameters are important and need to be monitored is subjective. Parameters are usually selected as important during a single initial setup phase. That is, the status of which parameter are important and which are non-important is fixed. Thus, prior art methods typically lack a mechanism of monitoring “non-important” parameters to detect when they may indeed become important. Similarly, what is also lacking is a method to determine when an important parameter becomes not as important thus, resulting in information that does not necessarily need monitoring.

In view of the foregoing, there is a long-felt need for a data mining method that updates alert levels in real time allowing for notification of significant changes in model parameters while minimizing false warnings and non-reporting of significance.

### SUMMARY OF THE INVENTION

Accordingly, methods and apparatus for reporting significant data mining changes are disclosed. In general, embodiments of the present invention address the shortcomings of the prior art through comparison over time of prediction model characteristics, such as inferences. Embodiments of the present invention detect trends in the model itself by detecting changes in levels of correlation (or any other model aspect) between individual elements of input data and targets of predictions. In this specific embodiment, users of the model are preferably alerted when an input characteristic or other model aspect, which was not important before, becomes important and when an input characteristic, which was important, loses its importance.

In one embodiment, a method of monitoring aspects of a prediction model over time is disclosed. In a first time period, a first prediction model is built based on data collected in the first time period. In a second time period, a second prediction model is built based on data collected in the second time period. The first and second models have a same prediction goal. A first state corresponding to characteristics of the first model while it was being built during the first time period is stored, and a second state corresponding to characteristics of the second model while it was being built during the second time period is also stored. When a significant difference occurs between the first state and the second state, an alert indicating such significant difference is produced. In a specific aspect, the building of the first model commences at the beginning of the first time period and the building of the second model commences at the beginning of the second time period.

In a specific implementation, the stored first state corresponds to the building of the first model during the entire first period and the stored second state corresponds to the building of the first model during the entire second period. In a further aspect, the first model is used to predict outcomes during the second time period. In another aspect, the building of the second model is independent of data collected during the first time period. In a further embodiment, the building of the first model is stopped at the second period's end.

In an alternative implementation, the significant difference is in the form of a correlation change in the effect that one or more input attributes have on predictions results produced by the first and second models in the first and second time periods, respectively. In a further feature, the correlation change is a decrease in the effect that the one or more input attributes have on the prediction result produced by the first model in the first time period as compared with the effect that the one or more input attributes have on the prediction result produced by the second model in the second time period. In another feature, the correlation change is an increase in the effect that the one or more input attributes have on the prediction result produced by the first model in the first time period as compared with the effect that the one or more input attributes have on the prediction result produced by the second model in the second time period. In one embodiment, a significant difference is present when the correlation change exceeds its estimated standard deviation multiplied by a predetermined confidence factor.

In another embodiment, the first and second models are in the form of self-governing neural networks and the significant difference is in the form of a difference in the first self-governing neural networks' configuration during operation in the first period as compared to the second self-governing neural networks' configuration during operation in the second time period. In another implementation, the significant difference is in the form of a change in an average frequency of a positive or negative outcome during the first period as compared to the second period. In another aspect, a root cause of the significant difference is determined when the alert is produced. In yet another embodiment, the first and second time periods each have a duration selected from a group consisting of a week, a month, an annual quarter, a year, and a decade.

In another embodiment, the invention pertains to a computer system operable to monitor aspects of a prediction model over time. The computer system includes one or more processors and one or more memory. At least one of the memory and processors are adapted to provide at least some of the above described method operations. In yet a further embodiment, the invention pertains to a computer program product for monitoring aspects of a prediction model over time. The computer program product has at least one computer readable medium and computer program instructions stored within at least one of the computer readable product configured to perform at least some of the above described method operations.

These and other features and advantages of the present invention will be presented in more detail in the following specification of the invention and the accompanying figures that illustrate by way of example the principles of the invention.

### BRIEF DESCRIPTION OF THE DRAWINGS

FIG. 1 is a diagrammatic representation of an exemplary first sales channel for which techniques of the present invention may be applied.

FIG. 2 is a diagrammatic representation of an exemplary second sales channel for which techniques of the present invention may be applied.

FIG. 3 is a diagram illustrating an exemplary distributed learning system in which techniques of the present invention may be implemented.

FIG. 4 is a flowchart illustrating a procedure for implementing a decision using an updated prediction model in accordance with one application of the present invention.

FIG. 5 illustrates a plurality of models that are built, implemented, and for which states are saved over a plurality of different time periods in accordance with one embodiment of the present invention.

FIG. 6 is a flowchart illustrating an alert procedure in accordance with a specific implementation of the present invention.

FIG. 7 is a block diagram of a general purpose computer system suitable for carrying out the processing in accordance with one embodiment of the present invention.

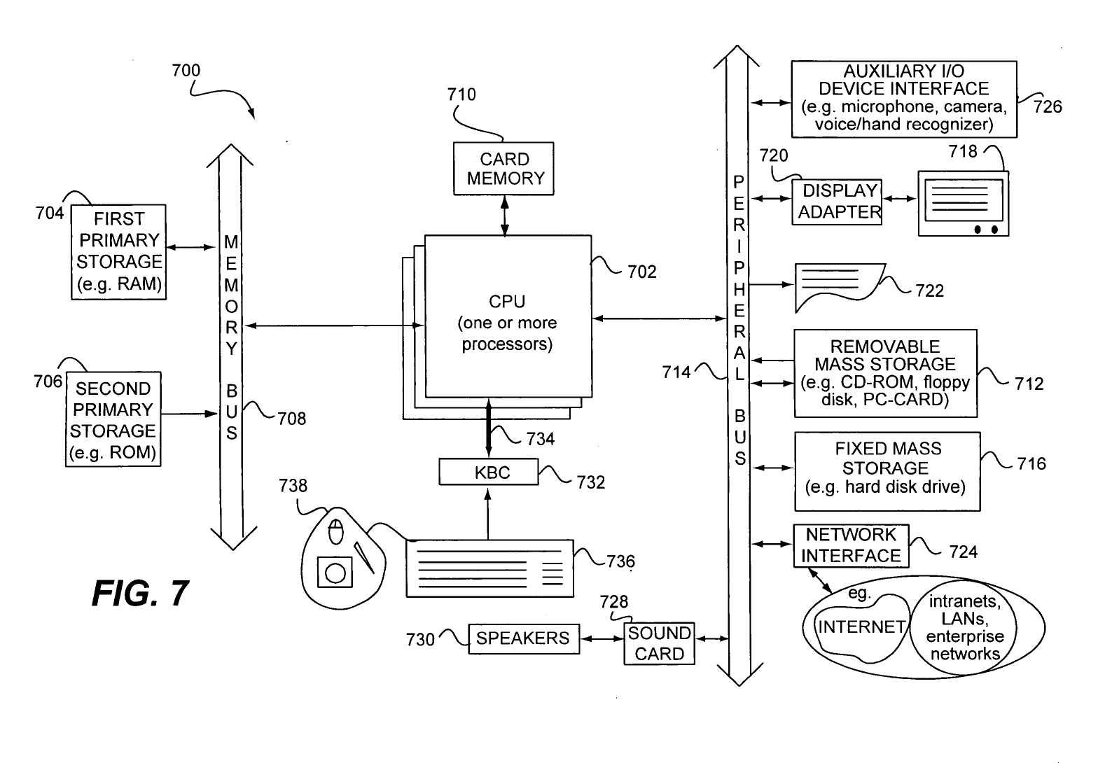

### DETAILED DESCRIPTION OF SPECIFIC EMBODIMENTS

Reference will now be made in detail to a specific embodiment of the invention. An example of this embodiment is illustrated in the accompanying drawings. While the invention will be described in conjunction with this specific embodiment, it will be understood that it is not intended to limit the invention to one embodiment. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

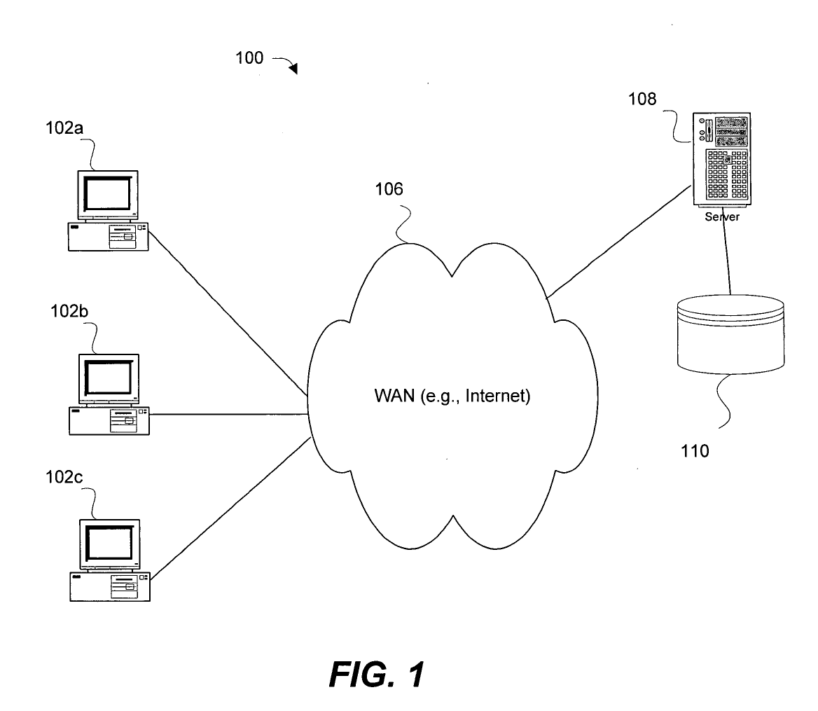

FIG. 1 is a diagrammatic representation of an exemplary first sales channel 100 for which techniques of the present invention may be applied. As shown, the sales channel 100 includes a plurality of hosts 102 and a web server 108 which are both coupled to a wide area network (WAN) 106, e.g., the Internet. Any suitable type of entity or user (such as a person or an automated process) may access the web server 108 via host device 102. The server 108 may also be in communication with one or more database 110. The web server 108 may be configured to provide various products and services to various users. For example, the web server 108 may include an on-line store for customers to purchase various products and an on-line service center for providing customers with FAQ's or trouble shooting help regarding their purchased products.

In a sales environment, potential customers on computers 102 or the like access the web server 108 via the Internet 106 or the like. Their experience at the website hosted by web server 108 is dictated or influenced by one or more prediction models running, for example, on the web server 108 and obtained from database 110, for example. The prediction model is self-learning, at least based in part, on the interactions of the potential customers and the website. Information regarding the customers and website interactions is preferably stored in database 110. It should be noted that the computers, network, servers, databases, machines, etc. that are illustrated in FIG. 1 are logical in nature, and some are all of their functionalities can be performed on one or more physical machines, systems, media, etc.

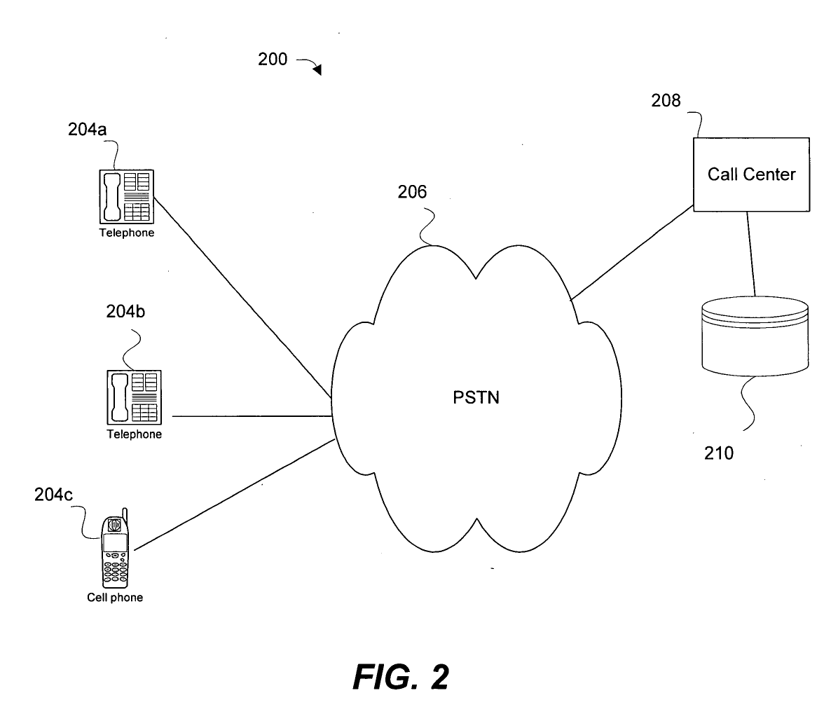

FIG. 2 illustrates an exemplary second sales channel 24 which has certain analogies with the exemplary first sales channel 100. In second sales channel 200, users may access call center 208 though individual telephones 204 or the like via a telephone system 206 (public switched telephone network or PSTN) or the like. The call center 208 may maintain a database 210 for essentially the same purposes that the web server 108 of FIG. 1 maintains the database 110 in the first sales channel 100. Users may communicate and interact with agents (human or automated) or an IVR system at the call center 108. Again, the telephones, telephone system, call center, and database, etc., of FIG. 2 are illustrated in a functional form and their actual physical manifestations may differ from implementation to implementation.

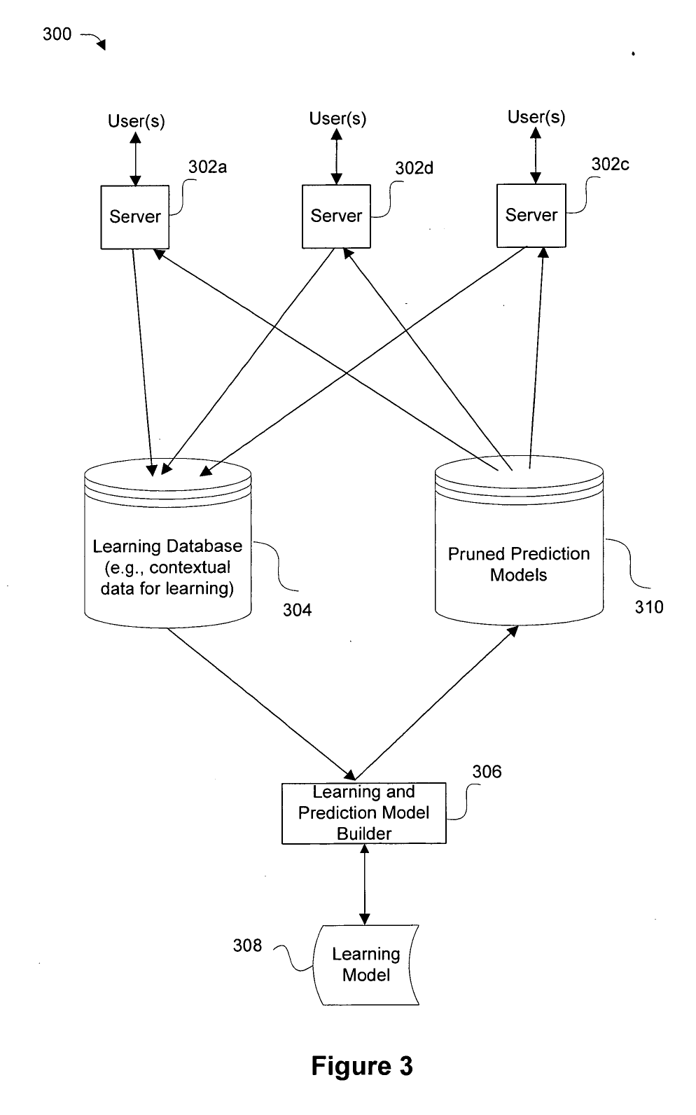

FIG. 3 is a diagram illustrating an exemplary distributed learning system 300 in which techniques of the present invention may be implemented. Of course, the present invention may be implemented in any suitable system that implements predictive modeling. As shown in FIG. 3, system 300 includes one or more interactive servers 302, a learning database 304, a prediction model repository 310, a learning and prediction model builder server 306, and a learning model 308. The learning system preferably includes a plurality of distributed interactive servers 302 although a single interactive server is also contemplated.

Interactive servers 302 execute one or more prediction models to determine specific transaction paths to follow, such as which web page or automated interactive voice message to present to a particular customer. A single prediction model may be used to predict the probability of a particular outcome or any number of outcomes based on a specific number of input attributes or contextual data and their corresponding values. Contextual data is in the form of a finite set of input factors which are deemed to have an effect on whether a particular goal or outcome is met when particular decisions or events occur. Input attributes may include attributes of a contacting entity (such as a potential or current customer), attributes of an answering entity (such as sales or service agent), time information regarding when specific events occur, etc. Alternatively, a plurality of prediction models may be used to determine the probability of a plurality of outcomes. Each single prediction model may be used to predict each single outcome probability. For example, a first prediction model may be used to determine the probabilities of achieving a first outcome when a particular decision (or action plan) is implemented with respect to various customer's with specific characteristics or profiles, and a second prediction model is used to determine the probabilities of achieving a second outcome when a particular decision (or action plan) is implemented with respect to various customer's with specific characteristics or profiles. In sum, any number of prediction models may be used to predict any number of outcomes under any number of different input attribute values.

The prediction models may be retrieved from (or sent by) one or more prediction models database 310. The interactive servers 302 also may be configured to collect contextual data regarding the input attributes used in the prediction model, as well as the results of the selected interaction or decision path. This contextual data is collected from one or more interactive servers 302 and stored in learning database 304.

Learning and prediction model builder 306 is generally configured to use the data from learning database 304 to update (the terms update, build, create, or modify are used interchangeably herein) one or more prediction models that are then sent to prediction model database 310. Additionally, model builder 306 may also prune one or more learning models 308 to generate one or more pruned prediction models, which are stored in prediction model database 310. A pruned prediction model is generally a learning model whose input attributes have been trimmed down to a subset of attributes (or attribute values) so as to be more efficient. That is, the pruned prediction model will typically have less input attributes to affect its results than the learning model from which it has been pruned. Pruned prediction models are used by the interactive servers 302 to formulate decisions or select particular interaction paths. Of course, pruning is not necessary for practicing the techniques of the present invention and the learning or prediction model may be used without trimming the input attributes. The builder 306 may also be configured to update the one or more learning models if necessary.

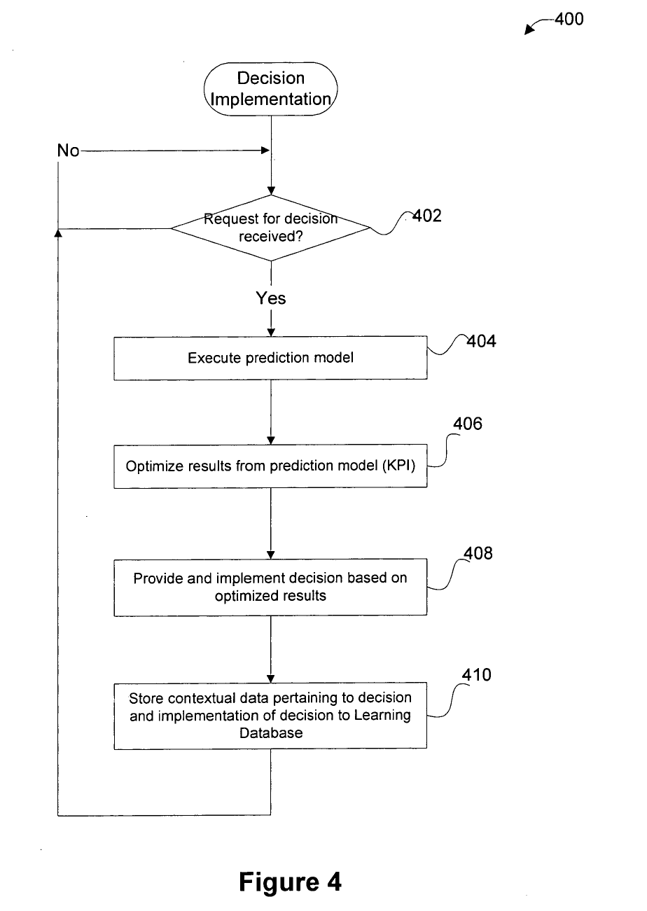

FIG. 4 is a flowchart illustrating a procedure 400 for implementing a decision using a prediction model in accordance with one embodiment of the present invention. The following procedure represents merely one example of a flow in which the techniques of the present invention may be implemented. In the example of FIG. 3, this procedure 400 may be executed on any one of servers 302, for example. Initially, a request for a decision may be received at operation 402. For instance, a customer may access a particular website of a company or call a company's service telephone number. The automatic process that is automatically interacting with the customer may be making a request for a particular decision regarding which web page, automated voice interaction, or particular live sales agent is to be presented to the particular customer. The request may be received at any time during the customer interaction process, e.g., at any web page in a series of sequentially presented web pages or at the beginning or at any intermediary point of an IVR telephone call. The request may also be made by a person, rather than an automatic process. For example, a sales representative may be making requests via a graphical user interface while interacting with a customer through some form of computer data exchange, such as a chat session, or a via a telephone interaction.

One or more prediction models are then executed based on the contextual data or input attributes associated with the particular decision request in operation 404. In a sales type application, the prediction model may produce a probability value for each potential offer being accepted by the customer if such offer is presented to the customer. In one embodiment, the prediction model may also assign values for each of a plurality of key performance indicators (“KPI's”) for each of the different decision choices (e.g., presentation of the different offers). In the sales offer example, the prediction model may output a value for a number of factors (or KPI's) that each correspond to how well a particular performance goal is expected to be met when each offer is presented. For instance, the performance goals may include both minimizing cost and maximizing revenue, as well as the probability of the offer being accepted if presented to the customer. In this example, the prediction model may determine that if a particular offer is presented it will result in $50 cost which is reflected in the “minimizing cost” KPI, an expected revenue increase of $90 for the “maximizing revenue” KPI, and a 27% value for the probability of acceptance KPI. A second offer may result in different KPI values if the second offer is presented.

Several suitable embodiments for generating a prediction model are further described in the above referenced, co-pending filed U.S. patent application Ser. No. 10/980,421 (Attorney Docket No. SIGMP004), entitled “Method and Apparatus for Automatically and Continuously Pruning Prediction Models in Real Time Based on Data Mining”, which application is incorporated herein by reference in its entirety for all purposes.

The KPI values for each decision (e.g., a particular offer is presented) may then be compared in an optimization operation 406. For example, it is determined which decision to implement based on the relative importance of the various KPI's of the decisions. Several suitable embodiments of optimization techniques are described in the above referenced, co-pending U.S. patent application Ser. No. 10/980,440 (Attorney Docket No. SIGMP006), entitled “Method and Apparatus for Optimizing the Results Produced by a Prediction Model”, which application is incorporated by reference herein in its entirety for all purposes.

The selected decision is then provided and implemented based on the optimized results in operation 408. For example, the selected offer is presented to the customer. The contextual data (e.g., input attributes and results of the decision) are then stored, for example, in the learning database 304 in operation 410. Any suitable input attributes that are likely to affect the outcome of the prediction model are retained. In the sales example, a customer's demographics, sales history, and specifics of their interactions with the sales center may be retained as contextual data. After the contextual data is stored, the decision implementation procedure 400 may then be repeated for the next decision request.

In general, the present invention includes techniques for producing alerts for significant changes in model states over time. For example, when input attributes have an increasing or decreasing effect on the prediction results, as compared from one time period to a next time period, an alert indicating a correlation change is produced. The alert mechanisms of the present invention are not limited to correlation changes in predictive models over time. Any aspect of the prediction model that may change over time may be monitored and an alert produced when such aspect changes. In another application, a self-governing neural net may alter its configuration (e.g., using three layers, instead of two) over time and such alterations may be monitored and alerts generated for changes in configuration. Other monitored model aspects may include changes in average frequencies of positive or negative outcomes, such as acceptance rates. The overall effect of an attribute and how predictive it is for a specific output can also change over time and such change can be monitored and reported. The change of raw numbers, like a specific count or a percentage, may also be monitored and reported.

These techniques for producing alerts may be implemented in any suitable environment. That is, the decision making systems described above are merely exemplary and are not necessary to practicing the techniques of the present invention. Additionally, the decision making flow described above with respect to FIG. 4 is merely exemplary and the techniques of the present invention may be utilized in any other suitable process that utilizes expected values produced by a prediction model.

An alert of state change in prediction models may be used for any suitable purpose, such as market research and root cause analysis. For instance, a significant increase in sales may be linked to a recent advertisement campaign. This information may then lead to increasing the level of advertisements or using the particular advertisement campaign in a wider geographic region in order to further sales. In another example, an alert may report changes in the amount of influence that certain input attributes are having on prediction outcomes. In a specific business situation, the model may initially determine that a potential customer's address is not significantly correlated with the probability of such potential customer buying a particular product, such as a specific type of automobile. That is, this specific type of automobile has about the same rate of sales in each sales region. Over time, however, the probability of purchasing this particular product may become highly predictable based on a potential customer's address. For instance, sales of a specific type of automobile may significantly increase for Californian residents and therefore, cause a prediction model to show an increase in the purchase probability for Californians. Said in another way, a model may determine that a potential customer's state of residence is now an important factor in the prediction of automobile sales. In general, different input attributes may become increasingly or decreasingly inferential to the prediction results over time, and alerts may be flexibly produced for these changes in inference.

In effect, the correlations observed by a learning predictive model, as well as other aspects of the model, may change from one time period to the next. The present invention provides mechanisms for tracking model changes over different discrete time periods. For example, the state of a learning model for a first time period is compared to the state of a learning model for a second time period. The compared learning models are both used to achieve a same prediction goal. For instance, they both predict whether a potential customer is going to purchase a particular product.

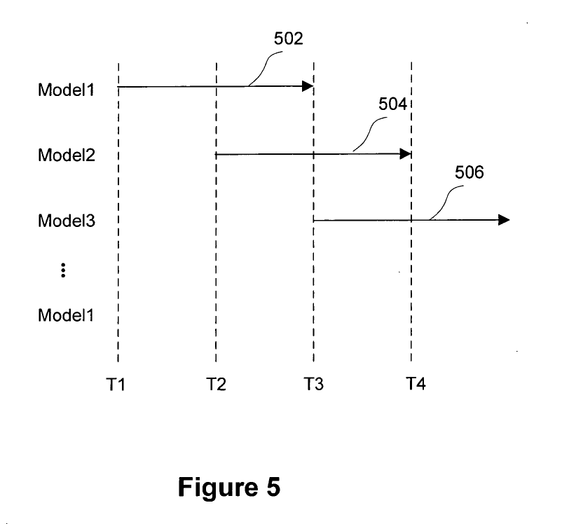

Any suitable technique may be used to compare the states of a model from two different time periods. Preferably, new models are built for each discrete time period. That is, a new model is built at the start of a specific time period and the state of the new model is saved at the end of the specific time period. This general technique allows the state of each model to be based on data from its own time period and not the time periods of other models. FIG. 5 illustrates a plurality of models that are built, implemented, and for which states are saved over a plurality of different time periods in accordance with one embodiment of the present invention. The time periods delineated by T1 through T4 can denote any suitable time durations, such as weeks, months, annual quarters, years, decades, etc. For examples, T1-T2 represents a first month; T2-T3 represents a second month; and T3-T4 represents a third month; etc.

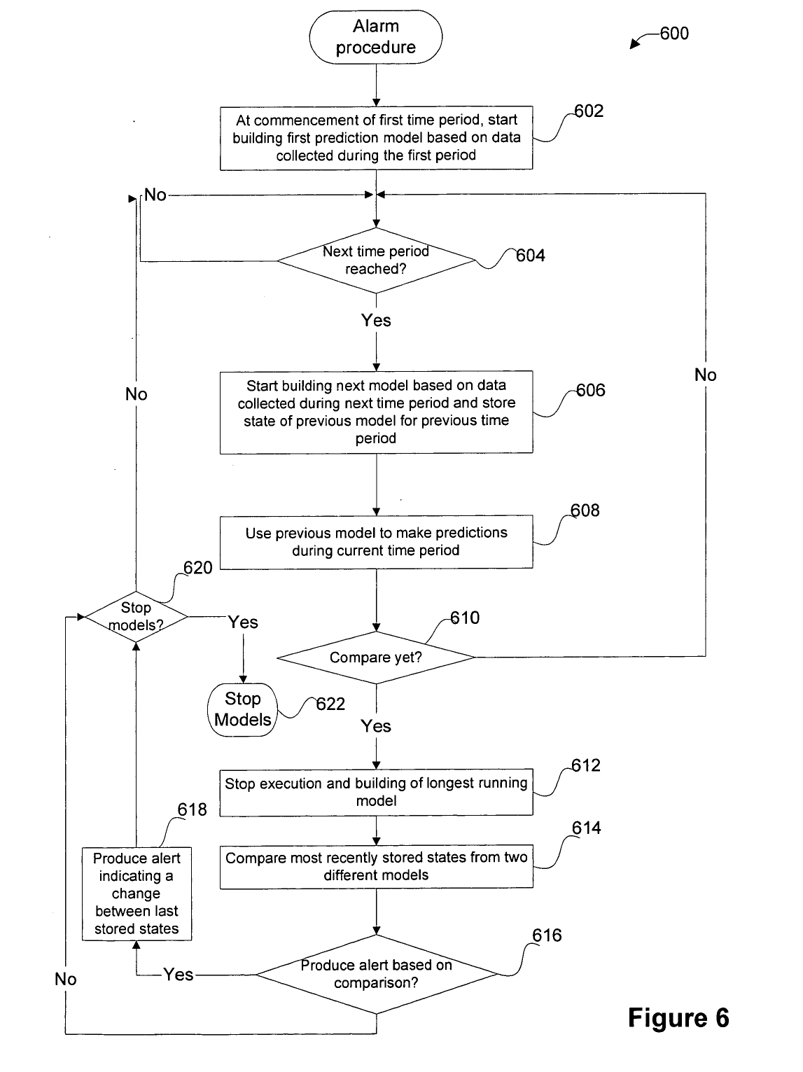

FIG. 6 is a flowchart illustrating an alert procedure that includes storing successive model states and producing an alert in accordance with a specific implementation of the present invention. FIG. 5 will be used in conjunction with FIG. 6 to describe techniques of the present invention. At commencement of a first time period T1-T2, building of a first model 502 is started and building of the first model is based on data collected in the first time period T1-T2 in operation 602 of FIG. 6.

As a prediction model is built, it generally tracks the relationships between the input attributes for various user entities and the results from implementing one or more decisions. The input attributes as well as the decisions are each a finite set. The input attributes are selected as possibly being relevant to affecting any of the prediction targets, such as predicting the probability of selling a red car to a specific type of customer. The prediction model will track what happens with respect to prediction targets when particular input attribute values are present and use this information to determine probabilities of achieving specific goals when specific input attribute values are present. Techniques for determining probability values for achieving specific goals under various input attribute conditions are well known to those skilled in the art. For example, several data mining techniques may be found in the textbook “Predictive Data Mining: A Practical Guide” by Sholom M. Weiss and Nitin Indurkhya, Published by Morgan Kaufmann (Aug. 1, 1997), ISBN: 1558604030, which textbook is incorporated herein by reference in its entirety for all purposes.

A prediction model generally keeps track of a plurality of counts of specific input attribute values (or combination of attribute values) for each of the prediction targets. For example, a count of the number of customers that are from California (one possible value of the “residential state” input attribute) who have purchased a red car (a particular prediction target) is retained. These counts may be defined as part of the “state” that is stored for a model. These count values may also be used to determine correlation values as part of the stored state of a model. Correlation values are typically obtained by measuring the number of times the input, output and their combination appear in the learning records (e.g., stored data). These counts may also be used to predict probability of such goals being met under various input attribute conditions when the collected data is enough to render the predictions to be statistically significant. Additionally, the outcomes of the prediction model may change over time as more data is collected and the outcomes may also be defined as part of the state saved for the model.

Referring back to FIGS. 5 and 6, after the first model commences building of itself, it is then determined whether a next time period T2 has been reached in operation 604. The procedure 600 may repeatedly determine whether the start of the next time period has occurred in operation 604 until the next time period is reached. Alternatively, the procedure 600 may simply wait until a trigger indicating the next time period occurs. When the next time period T2 is reached, the building of a next model 504 is then started based on data collected during this next time period T2 and the state of the previous model 502 for the previous time period T1 is stored in operation 606.

In sum, the state of the first model 502 as it was being newly built during the first time period T1 based on data only from the first time period T1 is stored. The state stored for the first model may include any parameter values related to the first model as it was built during its time period. For example, the counts for the input, output and their combinations may be stored, and from these stored values the correlation and the overall predictiveness can be computed and therefore compared.

The second model 504 is newly built in the second time period T2-T3 based on data collected only from such time period T2-T3. That is, the state stored for second model 504 is preferably not dependent on data collected from a previous time period. The previous model 502 that was started in the first time period T1-T2 is used to make predictions during the current time period T2-T3 in operation 608. During the next time period T2-T3, information continues to be added to the first model 502. During at least a portion of the second time period T2-T3, the new second model 504 will not have a high confidence level since it has only collected data for a single time period. In contrast, the first model 502 will have a higher confidence level in the second time period T2-T3 since it has already built itself based on data collected during the previous time period T1-T2.

It is then determined whether a comparison of states is to be made yet in operation 610. In general, this operation is merely used to determine whether at least two different model states from two different time periods have been stored yet. In the present example, only the state of the first model 510 for the first time period T1-T2 has been stored so far. Thus, the procedure 600 goes to operation 604 to wait for the next time period T3. When the next time period T3 is reached, a next model 506 then begins building itself based on data collected in this next time period T3-T4 and the state of the previous model 504 for the previous time period T2-T3 is then stored in operation 606. For this time period T3-T4, the previous second model 504 may then be used for predictions in operation 608, while the new model 506 learns based on data from the third time period T3-T4.

After two model states from two different time periods have been stored, it may then be determined that a comparison can be made in operation 610. The building of the longest running model (e.g., first model 502) may also end, for example, at the third month T3 in operation 612. The most recently stored states stored for two different models 502 and 504 and two different time periods T1-T2 and T2-T3, respectively, are then compared in operation 614.

It is then determined whether an alert is to be produced based on the comparison result in operation 616. Determination of whether to produce an alert may include any suitable criteria. In one implementation, an alert is produced when a significant difference occurs in the two compared model states from the two different time periods.

In one example, the difference between two correlation values from the two compared time periods is considered significant when it exceeds its estimated standard deviation multiplied by a configurable confidence factor. If we have two values of correlation C₁ and C₂ with estimated deviations σ₁ and σ₂, the difference between the correlation values is considered significant if
|C₁−C₂|>F_{c}\sqrt{σ₁²+σ₂²} (Equation I)
where F_{c} is a configurable confidence factor that is usually chosen between 1 and 2.

Standard deviations σ₁ and σ₂ are estimated as:

$${σ}_{i} = {C}_{i} \frac{1}{\sqrt{{N}_{i}}} \qquad ( Equation II )$$

where Nᵢ is the size of the statistical sample contributing to the prediction of Cᵢ.

When it is determined that an alert is to be produced (e.g., correlation values have significantly changed from one time period to the next), an alert is produced indicating the significant change (e.g., correlation value change) between the two model states or time periods in operation 618. Otherwise, this operation is skipped.

The alert procedure may proceed to operation 604 and await a next time period or it may determine whether the models that is currently being build are to be stopped in operation 620. The model building or implementation may be stopped for any purpose, such as to adjust a model parameter. If the models are to be stopped, they are stopped in operation 622. Otherwise, the procedure goes to operation 604, where it awaits the next time period.

As each discrete time period commences and a new model is built, the state of the model during the previous time period is saved. For instance, the state of the first model 502 is saved for T1-T2 and the state of the second model 504 is saved for T2-T3. In general, the model states for the different time periods are compared and an alert is sent if significant changes in the models occur between two different time periods. The state of a model from a first time period may be compared to the state of a model from a consecutive second time period. This alert system reports any significant changes, negative or positive. For example, a new or stronger correlation between an input attribute and the predicted outcome may be reported, as well as a weaker correlation between an input attribute and a predicted outcome. In parallel, models that already have enough experience are used to make decisions. For example, the first model is used during its second time period T2-T3 of operation, while the second model 504 is used during its own second period T3-T4 of operation.

The above described alert techniques may be applied to any suitable type of model. For instance, a model may predict a single outcome, positive or negative, or predict a plurality of outcomes, positive and/or negative. The prediction may take the form of a probability value or a single score that is correlated to a probability value. Alternatively, the prediction may take the form of a plurality of scores that each correspond to the likelihood of a positive or negative outcome. The model may be configured to observe a large set of input attributes in learning how to predict outcomes. The model may also be configured to prune the set of input attributes based on their observed relevance over time as described above.

Embodiments of the present invention have several associated advantages. For example, since states of models that have been newly built over a specific time period are stored, discrete model states can be compared without biasing the comparison results with data from other previous time periods. That is, the effect that data from a discrete time period has on each stored model state may be isolated from the effect of data from other time periods. Additionally, since the most recent model that has at least a time period of experience is used for predictions, the prediction results can be both timely (not based on old, stale data) and have a higher confidence level than if a newer model were utilized.

The present invention may employ various computer-implemented operations involving information stored in computer systems. These operations include, but are not limited to, those requiring physical manipulation of physical quantities. Usually, though not necessarily, these quantities take the form of electrical or magnetic signals capable of being stored, transferred, combined, compared, and otherwise manipulated. The operations described herein that form part of the invention are useful machine operations. The manipulations performed are often referred to in terms such as, producing, identifying, running, determining, comparing, executing, downloading, or detecting. It is sometimes convenient, principally for reasons of common usage, to refer to these electrical or magnetic signals as bits, values, elements, variables, characters, or the like. It should remembered, however, that all of these and similar terms are to be associated with the appropriate physical quantities and are merely convenient labels applied to these quantities.

The present invention also relates to a device, system or apparatus for performing the aforementioned operations. The system may be specially constructed for the required purposes, or it may be a general purpose computer selectively activated or configured by a computer program stored in the computer. The processes presented above are not inherently related to any particular computer or other computing apparatus. In particular, various general purpose computers may be used with programs written in accordance with the teachings herein, or, alternatively, it may be more convenient to construct a more specialized computer system to perform the required operations.

FIG. 8 is a block diagram of a general purpose computer system 800 suitable for carrying out the processing in accordance with one embodiment of the present invention. Other computer system architectures and configurations can be used for carrying out the processing of the present invention. Computer system 800, made up of various subsystems described below, includes at least one microprocessor subsystem (also referred to as a central processing unit, or CPU) 802. That is, CPU 802 can be implemented by a single-chip processor or by multiple processors. CPU 802 is a general purpose digital processor which controls the operation of the computer system 800. Using instructions retrieved from memory, the CPU 802 controls the reception and manipulation of input information, and the output and display of information on output devices.

CPU 802 is coupled bi-directionally with a first primary storage 804, typically a random access memory (RAM), and uni-directionally with a second primary storage area 806, typically a read-only memory (ROM), via a memory bus 808. As is well known in the art, primary storage 804 can be used as a general storage area and as scratch-pad memory, and can also be used to store input data and processed data. It can also store programming instructions and data, in addition to other data and instructions for processes operating on CPU 802, and is typically used for fast transfer of data and instructions bi-directionally over memory bus 808. Also, as is well known in the art, primary storage 806 typically includes basic operating instructions, program code, data and objects used by the CPU 802 to perform its functions. Primary storage devices 804 and 806 may include any suitable computer-readable storage media, described below, depending on whether, for example, data access needs to be bi-directional or uni-directional. CPU 802 can also directly and very rapidly retrieve and store frequently needed data in a cache memory 810.

A removable mass storage device 812 provides additional data storage capacity for the computer system 800, and is coupled either bi-directionally or uni-directionally to CPU 802 via a peripheral bus 814. For example, a specific removable mass storage device commonly known as a CD-ROM typically passes data uni-directionally to the CPU 802, whereas a floppy disk can pass data bi-directionally to the CPU 802. Storage 812 may also include computer-readable media such as magnetic tape, flash memory, signals embodied in a carrier wave, Smart Cards, portable mass storage devices, and other storage devices. A fixed mass storage 816 also provides additional data storage capacity and is coupled bi-directionally to CPU 802 via peripheral bus 814. Generally, access to these media is slower than access to primary storages 804 and 806. Mass storage 812 and 816 generally store additional programming instructions, data, and the like that typically are not in active use by the CPU 802. It will be appreciated that the information retained within mass storage 812 and 816 may be incorporated, if needed, in standard fashion as part of primary storage 804 (e.g. RAM) as virtual memory.

In addition to providing CPU 802 access to storage subsystems, the peripheral bus 814 is used to provide access to other subsystems and devices as well. In the described embodiment, these include a display monitor 818 and adapter 820, a printer device 822, a network interface 824, an auxiliary input/output device interface 826, a sound card 828 and speakers 830, and other subsystems as needed.

The network interface 824 allows CPU 802 to be coupled to another computer, computer network, or telecommunications network using a network connection as referred to. Through the network interface 824, it is contemplated that the CPU 802 might receive information, e.g., objects, program instructions, or bytecode instructions from a computer in another network, or might output information to a computer in another network in the course of performing the above-described method steps. Information, often represented as a sequence of instructions to be executed on a CPU, may be received from and outputted to another network, for example, in the form of a computer data signal embodied in a carrier wave. An interface card or similar device and appropriate software implemented by CPU 802 can be used to connect the computer system 800 to an external network and transfer data according to standard protocols. That is, method embodiments of the present invention may execute solely upon CPU 802, or may be performed across a network such as the Internet, intranet networks, or local area networks, in conjunction with a remote CPU that shares a portion of the processing. Additional mass storage devices (not shown) may also be connected to CPU 802 through network interface 824.

Auxiliary I/O device interface 826 represents general and customized interfaces that allow the CPU 802 to send and, more typically, receive data from other devices. Also coupled to the CPU 802 is a keyboard controller 832 via a local bus 834 for receiving input from a keyboard 836 or a pointer device 838, and sending decoded symbols from the keyboard 836 or pointer device 838 to the CPU 802. The pointer device may be a mouse, stylus, track ball, or tablet, and is useful for interacting with a graphical user interface.

In addition, embodiments of the present invention further relate to computer storage products with a computer readable medium that contain program code for performing various computer-implemented operations. The computer-readable medium is any data storage device that can store data which can thereafter be read by a computer system. Examples of computer-readable media include, but are not limited to, all the media mentioned above, including hard disks, floppy disks, and specially configured hardware devices such as application-specific integrated circuits (ASICs) or programmable logic devices (PLDs). The computer-readable medium can also be distributed as a data signal embodied in a carrier wave over a network of coupled computer systems so that the computer-readable code is stored and executed in a distributed fashion.

It will be appreciated by those skilled in the art that the above described hardware and software elements are of standard design and construction. Other computer systems suitable for use with the invention may include additional or fewer subsystems. In addition, memory bus 808, peripheral bus 814, and local bus 834 are illustrative of any interconnection scheme serving to link the subsystems. For example, a local bus could be used to connect the CPU to fixed mass storage 816 and display adapter 820. The computer system referred to in FIG. 8 is but an example of a computer system suitable for use with the invention. Other computer architectures having different configurations of subsystems may also be utilized.

Although the foregoing invention has been described in some detail for purposes of clarity of understanding, it will be apparent that certain changes and modifications may be practiced within the scope of the appended claims. For instance, the following claims often use the article “a” or “an” and use of such article does not limit the claim scope to a single element. Therefore, the described embodiments should be taken as illustrative and not restrictive, and the invention should not be limited to the details given herein but should be defined by the following claims and their full scope of equivalents.

1. A method of monitoring aspects of a prediction model over time, the method comprising:
(a) in a first time period, building a first prediction model based on data collected in the first time period;
(b) in a second time period, building a second prediction model based on data collected in the second time period, wherein the first and second models have a same prediction goal;
(c) storing a first state corresponding to characteristics of the first model while it was being built during the first time period;
(d) storing a second state corresponding to characteristics of the second model while it was being built during the second time period; and
(e) when a significant difference occurs between the first state and the second state, producing an alert indicating such significant difference.

2. A method as recited in claim 1, wherein the building of the first model commences at the first time period's beginning and the building of the second model commences at the second time period's beginning.

3. A method as recited in claim 2, wherein the stored first state corresponds to the building of the first model during the entire first period and the stored second state corresponds to the building of the first model during the entire second period.

4. A method as recited in claim 3, wherein the first model is used to predict outcomes during the second time period.

5. A method as recited in claim 2, wherein the building of the second model is independent of data collected during the first time period.

6. A method as recited in claim 3, further comprising stopping the building of the first model at the second period's end.

7. A method as recited in claim 1, wherein the significant difference is in the form of a correlation change in the effect that one or more input attributes have on predictions results produced by the first and second models in the first and second time periods, respectively.

8. A method as recited in claim 7, wherein the correlation change is a decrease in the effect that the one or more input attributes have on the prediction result produced by the first model in the first time period as compared with the effect that the one or more input attributes have on the prediction result produced by the second model in the second time period.

9. A method as recited in claim 7, wherein the correlation change is an increase in the effect that the one or more input attributes have on the prediction result produced by the first model in the first time period as compared with the effect that the one or more input attributes have on the prediction result produced by the second model in the second time period.

10. A method as recited in claim 7, wherein a significant difference is present when the correlation change exceeds its estimated standard deviation multiplied by a predetermined confidence factor.

11. A method as recited in claim 1, wherein the first and second models are in the form of self-governing neural networks and the significant difference is in the form of a difference in the first self-governing neural networks' configuration during operation in the first period as compared to the second self-governing neural networks' configuration during operation in the second time period.

12. A method as recited in claim 1, wherein the significant difference is in the form of a change in an average frequency of a positive or negative outcome during the first period as compared to the second period.

13. A method as recited in claim 1, further comprising determining a root cause of the significant difference when the alert is produced.

14. A method as recited in claim 1, wherein the first and second time periods each have a duration selected from a group consisting of a week, a month, an annual quarter, a year, and a decade.

15. A computer system operable to monitor aspects of a prediction model over time, the computer system comprising:
one or more processors;
one or more memory, wherein at least one of the processors and memory are adapted for:
(a) in a first time period, building a first prediction model based on data collected in the first time period;
(b) in a second time period, building a second prediction model based on data collected in the second time period, wherein the first and second models have a same prediction goal;
(c) storing a first state corresponding to characteristics of the first model while it was being built during the first time period;
(d) storing a second state corresponding to characteristics of the second model while it was being built during the second time period; and
(e) when a significant difference occurs between the first state and the second state, producing an alert indicating such significant difference.

16. A computer system as recited in claim 15, wherein the building of the first model commences at the first time period's beginning and the building of the second model commences at the second time period's beginning.

17. A computer system as recited in claim 16, wherein the stored first state corresponds to the building of the first model during the entire first period and the stored second state corresponds to the building of the first model during the entire second period.

18. A computer system as recited in claim 17, wherein the first model is used to predict outcomes during the second time period.

19. A computer system as recited in claim 16, wherein the building of the second model is independent of data collected during the first time period.

20. A computer system as recited in claim 15, wherein the significant difference is in the form of a correlation change in the effect that one or more input attributes have on predictions results produced by the first and second models in the first and second time periods, respectively.

21. A computer system as recited in claim 19, wherein the correlation change is a decrease in the effect that the one or more input attributes have on the prediction result produced by the first model in the first time period as compared with the effect that the one or more input attributes have on the prediction result produced by the second model in the second time period.

22. A computer system as recited in claim 19, wherein the correlation change is an increase in the effect that the one or more input attributes have on the prediction result produced by the first model in the first time period as compared with the effect that the one or more input attributes have on the prediction result produced by the second model in the second time period.

23. A computer system as recited in claim 19, wherein a significant difference is present when the correlation change exceeds its estimated standard deviation multiplied by a predetermined confidence factor.

24. A computer system as recited in claim 15, wherein the first and second models are in the form of self-governing neural networks and the significant difference is in the form of a difference in the first self-governing neural networks' configuration during operation in the first period as compared to the second self-governing neural networks' configuration during operation in the second time period.

25. A computer system as recited in claim 15, wherein the significant difference is in the form of a change in an average frequency of a positive or negative outcome during the first period as compared to the second period.

26. A computer system as recited in claim 15, wherein at least one of the processors and memory are further adapted for determining a root cause of the significant difference when the alert is produced.

27. A computer system as recited in claim 15, wherein the first and second time periods each have a duration selected from a group consisting of a week, a month, an annual quarter, a year, and a decade.

28. A computer program product for monitoring aspects of a prediction model over time, the computer program product comprising:
at least one computer readable medium;
computer program instructions stored within the at least one computer readable product configured for:
(a) in a first time period, building a first prediction model based on data collected in the first time period;
(b) in a second time period, building a second prediction model based on data collected in the second time period, wherein the first and second models have a same prediction goal;
(c) storing a first state corresponding to characteristics of the first model while it was being built during the first time period;
(d) storing a second state corresponding to characteristics of the second model while it was being built during the second time period; and
(e) when a significant difference occurs between the first state and the second state, producing an alert indicating such significant difference.

29. A computer program product as recited in claim 28, wherein the building of the first model commences at the first time period's beginning and the building of the second model commences at the second time period's beginning.

30. A computer program product as recited in claim 29, wherein the stored first state corresponds to the building of the first model during the entire first period and the stored second state corresponds to the building of the first model during the entire second period.

31. A computer program product as recited in claim 30, wherein the first model is used to predict outcomes during the second time period.

32. A computer program product as recited in claim 29, wherein the building of the second model is independent of data collected during the first time period.

33. A computer program product as recited in claim 28, wherein the significant difference is in the form of a correlation change in the effect that one or more input attributes have on predictions results produced by the first and second models in the first and second time periods, respectively.

34. A computer program product as recited in claim 33, wherein the correlation change is a decrease in the effect that the one or more input attributes have on the prediction result produced by the first model in the first time period as compared with the effect that the one or more input attributes have on the prediction result produced by the second model in the second time period.

35. A computer program product as recited in claim 33, wherein the correlation change is an increase in the effect that the one or more input attributes have on the prediction result produced by the first model in the first time period as compared with the effect that the one or more input attributes have on the prediction result produced by the second model in the second time period.

36. A computer program product as recited in claim 28, wherein the significant difference is in the form of a change in an average frequency of a positive or negative outcome during the first period as compared to the second period.

37. A computer program product as recited in claim 28, where the computer program instructions stored within the at least one computer readable product is further configured for determining a root cause of the significant difference when the alert is produced.
